(19) United States
(12) Patent Application Publication
(10) Pub. No.: US 2019/0357444 A1
(43) Pub. Date: Nov. 28, 2019

(54) Garden Scissors

(71) Applicant: Shang Gu Enterprise Co., Ltd., Hemei Township (TW)

(72) Inventor: Chu-Lan Lin, Hemei Township (TW)

(21) Appl. No.: 15/990,799

(22) Filed: May 28, 2018

(51) Int. Cl. A01G 3/053; A01G 3/08

(52) U.S. Cl. CPC A01G 3/053; A01G 3/085

(57) ABSTRACT

A garden scissors of the present invention includes a chassis, a transmission mechanism, a driving line, and a cutter. The transmission mechanism is rotatably disposed to the chassis. The transmission mechanism includes a pulley portion, a gear portion, and a flywheel portion, which rotate simultaneously. The gear portion is located between the pulley portion and the flywheel portion. An end of the driving line is rolled on the pulley portion. The cutter has an engagement portion engaged with the gear portion. Thus, the pulley portion, the gear portion, and the cutter are rotated when the driving line is pulled away from the pulley portion, driving the cutter to pivot to cut branches. Therefore, the flywheel portion of the transmission mechanism laying on the chassis, supporting and balancing the force exerted on and the movements of the pulley portion and the gear portion. The structure of the garden scissors is then stabilized.

### BACKGROUND OF THE INVENTION

### Field of the Invention

The present invention relates to a scissors, in particularly used for trimming branches.

### Description of the Prior Art

Currently, some garden scissors are made as if a long pole so as to extend to the branches and twigs of trees or shrubs for trimming the branches and twigs. For example, U.S. Pat. No. 6,748,663 reveals a lopper for trimming. Such garden scissors, or named as a lopper, is mainly configured as a long pole with a rotatable blade disposed at the front end thereof. The blade is connected to a chain. The opposite end of the chain is connected to a wheel which a driving line is wounded around. The driving line extends to the rear end of the garden scissors. User may pull the driving line from the rear end to rotate the wheel, driving the blade to rotate via the chain for trimming.

However, the structure of the garden scissors mentioned above may not strong enough in heavy duty operation. In view of the force transmission path in the garden scissors mentioned, force is initially exerted on the driving line, passed to the wheel and chain, and at last passed to the blade. The driving line and the chain are wounded on different axial position of the wheel, rather than connected together directly. The extension lines of the driving line and the chain are skew lines. Thus, the forces exerted on the driving line and the chain generates a non-axial torque on the wheel. When the user tries to cut a bough or a larger branch, the user may pull the driving line harder, exerting larger force on the blade. Therefore, a larger torque will be generated on the wheel, leading swaying or inclining of the wheel. The garden scissors could be damaged or destroyed due to the swaying or inclining caused by the unstable structure and the force exerted thereon.

On the other hand, for cutting a bough or a larger branch, the scissors should be made of materials which have higher hardness and stiffness. Also, the structure of the scissors should be designed as strong as it could be. However, such material and structure are usually weighted heavier. When users lift the scissors by its rear end to reach and to trim the branches, the weight of the scissors can be a heavy burden to the users.

The present invention is, therefore, arisen to obviate or at least mitigate the above mentioned disadvantages.

### SUMMARY OF THE INVENTION

The main object of the present invention is to provide a garden scissors which has a stabilized structure.

Another object of the present invention is to provide a garden scissors which could be designed lighter to alleviate physical burden of the user.

To achieve the above and other objects, a garden scissors of the present invention includes a chassis, a transmission mechanism, a driving line, and a cutter. The chassis has a fixed cutting edge. The transmission mechanism is disposed in the chassis. The transmission mechanism is rotatable about a central axis. The transmission mechanism includes a pulley portion, a gear portion, and a flywheel portion. The pulley portion, the gear portion, and the flywheel portion are rotatable simultaneously about the central axis. The gear portion is located between the pulley portion and the flywheel portion. The flywheel portion has a radius larger than radius of the gear portion. The driving line has an end rolled and fixed on the pulley portion and another end extending away from the pulley portion. The cutter is rotatably disposed to the chassis about a pivot axis. The cutter has an engagement portion and an active cutting edge. The engagement portion is engaged with the gear portion. The cutter is rotated by the gear portion to bring the active cutting edge moving approach to or away from the fixed cutting edge.

With the garden scissors above, user may pull the driving line to rotate the pulley portion. The gear portion is then rotated, making the cutter to rotate and to trim the branch. The flywheel portion is connected to the gear portion away from the pulley portion, balancing the gear portion by providing inertia or by abutting against the chassis. The non-axial torque is strutted, and the inclining cause by the torque is resisted. Structure of the garden scissors is strengthened.

In addition, with a strengthened garden scissors, manufacturer can choose more lightened materials to produce the garden scissors without damaging durability of the end products. The garden scissors can be produced with light weight to reduce physical burden to the users.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a breakdown drawing showing a first embodiment of the present invention;

FIG. 3 is a profile showing a first embodiment of the present invention;

FIG. 4 is a combination showing partial elements of a first embodiment of the present invention;

FIG. 5 is a breakdown drawing showing a second embodiment of the present invention;

FIG. 6 is a profile showing a second embodiment of the present invention.

### DETAILED DESCRIPTION OF THE PREFERRED EMBODIMENTS

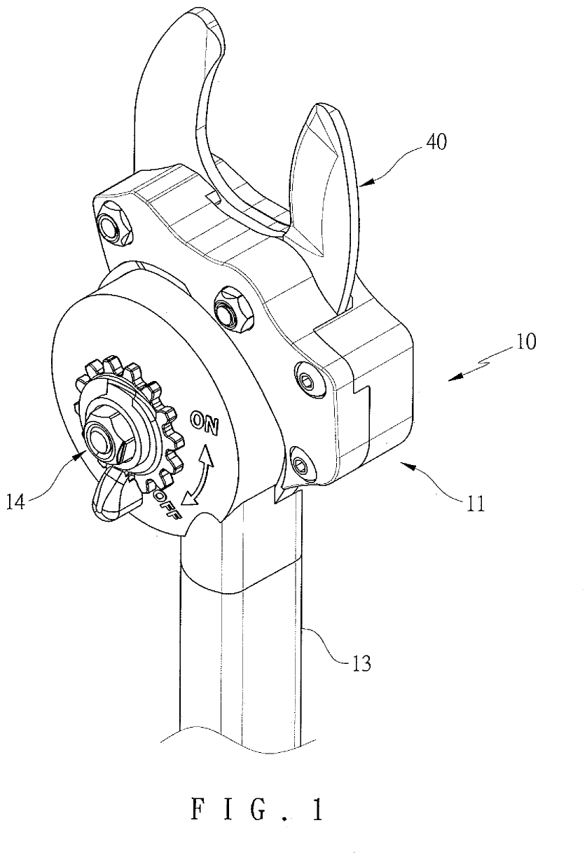

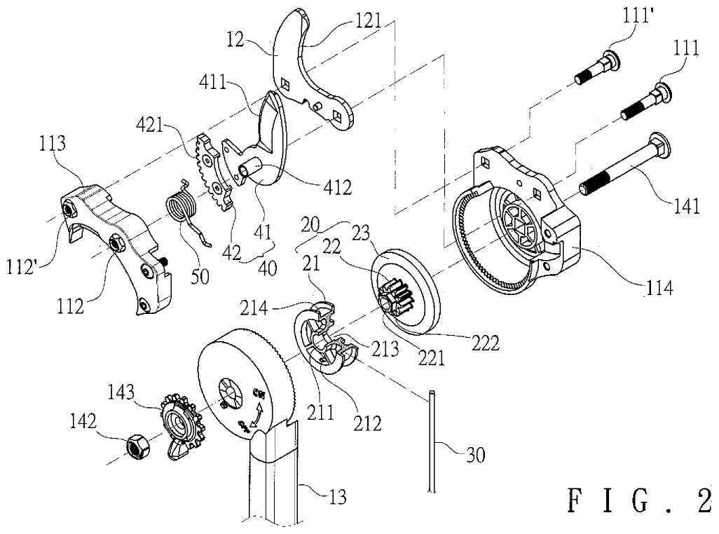

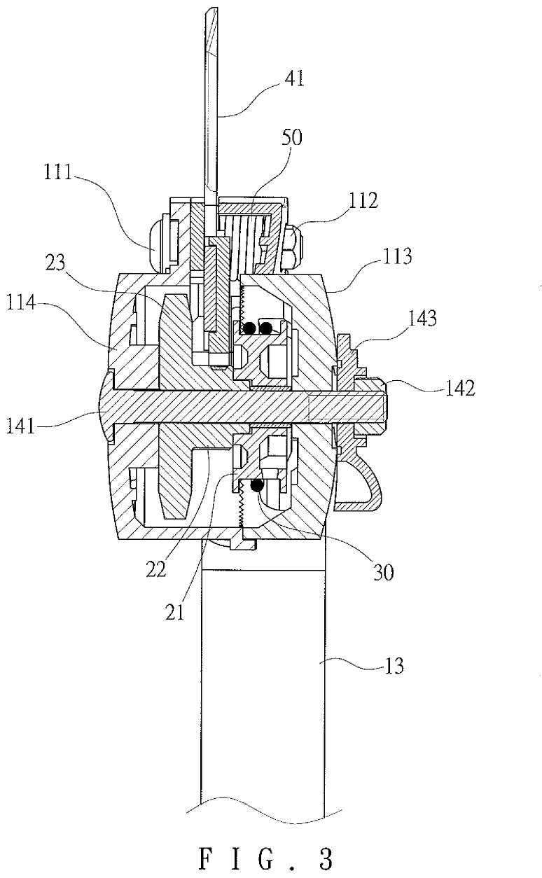

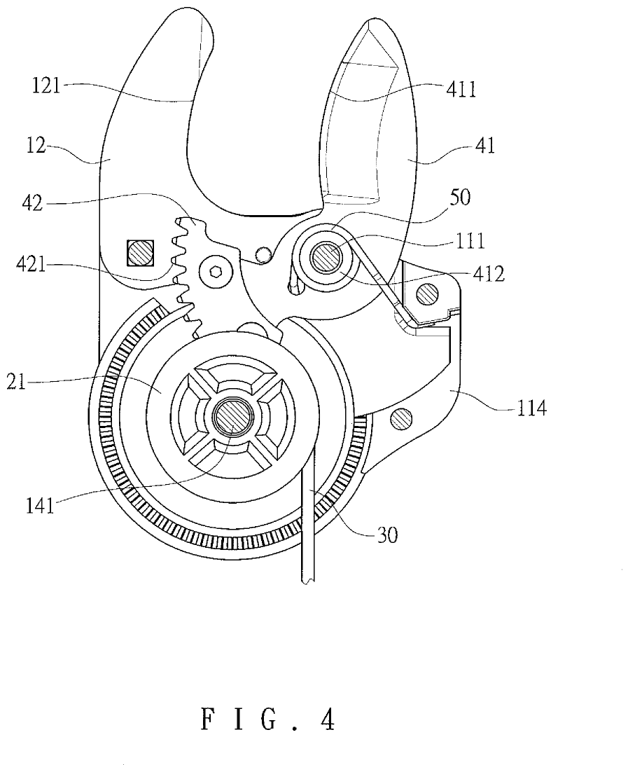

The present embodiment reveals a garden scissors which can be used for trimming branches. Please refer to FIG. 1 to FIG. 4 for a first embodiment of the present invention. The garden scissors of the embodiment includes a chassis 10, a transmission mechanism 20, a driving line 30, a cutter 40, and an elastic member 50.

The chassis 10 includes a head portion 11, a fixed blade 12, a handle portion 13, and an axial portion 14. The head portion includes screws 111, 111′, nuts 112, 112′, a left sub-portion 113, and a right sub-portion 114. The left sub-portion 113 is fixed to the right sub-portion 114 by the screws 111, 111′ and the nuts 112, 112′. The fixed blade 12 is clipped and fixed between the left sub-portion 113 and the right sub-portion 114. The fixed blade 12 extends through the seam between the left sub-portion 113 and the right sub-portion 114 and extends upwardly, forming a fixed cutting edge 121 thereon. The handle portion 13 is configured as a long pole. The axial portion 14 includes a threaded axle 141, a nut 142, and an adjuster 143. One end of the handle portion 13 is attached to the right sub-portion 114 by the threaded axle 141 and the nut 142. The adjuster 143 is sandwiched between the nut 142 and the handle portion 13. The adjuster 143 can be rotated about the threaded axle 141 to press against the handle portion 13 toward the right sub-portion 114 or to loosen the handle portion 13 and the right sub-portion 114. The handle portion 13 and the right sub-portion 114 are able to rotate about a central axis defined by the threaded axle 141 with respect to each other when the adjuster 143 is rotated to loosen thereof.

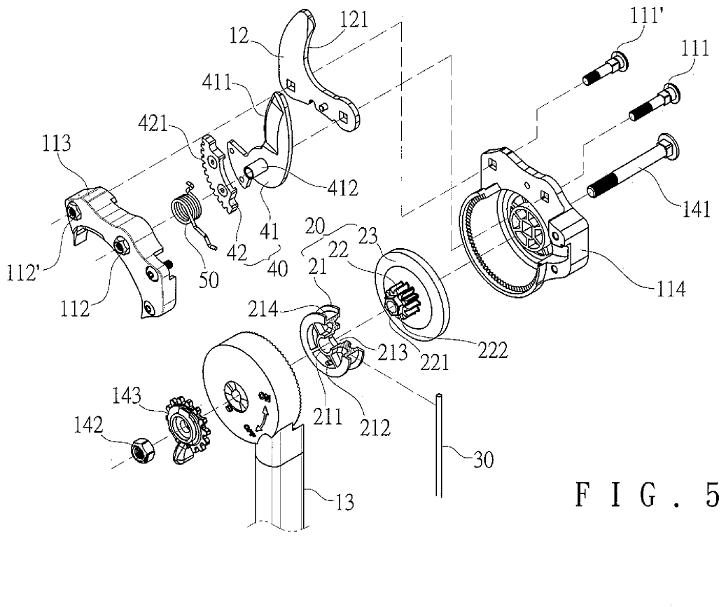

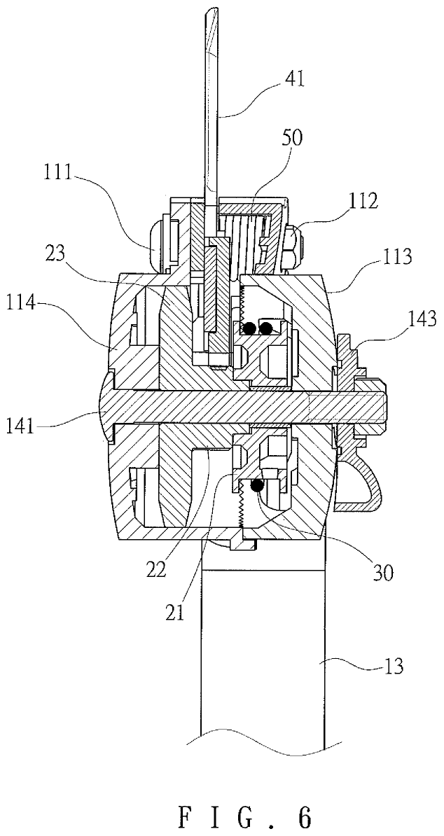

The transmission mechanism 20 is positioned between the handle portion 13 and the right sub-portion 114. The transmission mechanism 20 includes a pulley portion 21, a gear portion 22, and a flywheel portion 23. The pulley portion 21 has an axial hole 211, a fixation hole 212, and a non-circular engagement hole 213. The threaded axle 141 penetrates across the axial hole 211 of the pulley portion 21, so that the pulley portion 21 is disposed to the chassis and is rotatable about the central axis defined by the threaded axle 141. The fixation hole 212 is located on an annular surface 214 of the pulley portion 21. The engagement hole 213 is a hexagonal hole, being coaxial with the axial hole 211. The gear portion 22 has a toothed annular surface, and has an axial hole 221 and a protrusion 222. The threaded axle 141 penetrates across the axial hole 221 of the gear portion 22, so that the gear portion 22 is disposed to the chassis and is rotatable about the central axis defined by the threaded axle 141. The protrusion 222 is a hexagonal prism, surrounding and being coaxial with the axial hole 221. The protrusion 22 protrudes toward the engagement hole 213, so as to be embedded in the engagement hole 213. The pulley portion 21 and the gear portion 22 are therefore buckled to each other and unable to rotate with respect to each other. The flywheel portion 23 and the gear portion 22 are integrally formed, so that the flywheel portion 23 is disposed to the chassis together with the gear portion 22 and is rotatable about the central axis. The pulley portion 21, the gear portion 22, and the flywheel portion 23 are therefore able to rotate simultaneously about the central axis. The flywheel portion 23 is located by the gear portion 22 away from the pulley portion 21. In other words, the gear portion 22 is located between the pulley portion 21 and the flywheel portion 23. The flywheel portion 23 has a sufficient radius and thickness. In the present embodiment, the radius of the flywheel portion 23 is larger than twice the radius of the gear portion 22, and the thickness of the flywheel portion 23 is larger than one third the thickness of the gear portion 22. The flywheel portion 23 is therefore able to serve as a supporting structure or to provide substantial inertia for the gear portion 22 and the threaded axle 141, stabilizing operation of the transmission mechanism 20. In the present embodiment, an abutting surface of the flywheel portion 23 away from the gear portion 22 abuts against the right sub-portion 114. The annular surface of the flywheel portion 23 is not directly contact the chassis. However, please refer to FIG. 5 to FIG. 6, the flywheel portion 23 may be enlarged to increase the radius. The annular surface of the flywheel portion 23 may slidably contact the chassis. The stability of the flywheel portion 23 is then strengthened for further stabilizing the transmission mechanism.

Please refer to FIG. 1 to FIG. 4. The gear portion 22 and the flywheel portion 23 are integrally formed. The pulley portion 21 is formed solely. With such configuration, the pulley portion 21, the gear portion 22, and the flywheel portion 23 of the transmission mechanism is suitable for being produced by injection molding, press molding, transfer molding, or other molding methods. Materials and molding methods may be selected for different abrasion resistance requirements in different parts and portions. However, separately formed pulley portion 21, gear portion 22, and flywheel portion 23 are also applicable. Or in other possible embodiments, the pulley portion 21 and the gear portion 22 could be formed integrally while the flywheel portion 23 is formed solely.

Besides, the annular surface of the gear portion 22 is formed with teeth thereon. Strength requirement of material of the gear portion 22 may different from that of the flywheel portion 23. Therefore, the gear portion 22 and the flywheel portion 23 can be made of two or more materials by double injection molding, bi-injection molding, insert molding, or other molding methods.

One end of the driving line 30 is rolled on the annular surface of the pulley portion 21, which the distal end thereof is fixed in the fixation hole 212. The other end of the driving line 30 extends away from the pulley portion 211 along the handle portion 13.

The cutter 40 includes an active blade 41 and a toothed member 42. The active blade 41 is sandwiched between the left sub-portion 113 and the right sub-portion 114. The screw 111 pierces across the active blade 41. The active blade 41 is rotatable about a pivot axis defined by the screw 111. The active blade 41 has an active cutting edge 411. The active cutting edge 411 faces toward the fixed cutting edge 131, moving approach to or away from the fixed cutting edge 131 when the active blade 41 rotates. The active blade 41 is further formed with a pole 412 which is configured coaxial with the screw 111. The toothed member 42 is firmly disposed to the active blade 41. The toothed member 42 is formed with an engagement portion 421 which has plural teeth arranged in and arc. The engagement portion 421 is engaged with the gear portion 22, so that the gear portion 22 brings the cutter 40, including the active blade 41 and the toothed member 42, to rotate about the pivot axis when the gear portion 22 rotates.

The elastic member 50 is a torsion spring, sleeving on the pole 412. One end of the elastic member 50 presses against the right sub-portion 114, and the other end presses against the cutter 40. The elastic member 50 provides an elastic force to the cutter 40, so that the active cutting edge 411 has a potential to move away from the fixed cutting edge 131.

Accordingly, the user may hold the garden scissors by the rear end of the handle portion 13 for trimming branches. The fixed cutting edge 131 and the active cutting edge 411 are moved to approach the branch. Then the user may pull the driving line 30 from the rear end of the handle portion 13. The driving line 30 drives the pulley portion 21 to rotate, bringing the gear portion 22 to rotate simultaneously. The gear portion 22 drives the toothed member 42 and the active blade 41 to rotate. The active cutting edge 411 is then moved toward the fixed cutting edge 131, cutting the branches between the active cutting edge 411 and the fixed cutting edge 131 off. When the user releases the driving line 30, the elastic force provided by the elastic member 50 drives the active cutting edge 411 to sway and to move away from the fixed cutting edge 131, driving the active blade 41, the toothed member 42, the gear portion 22, the pulley portion 21, and the driving line 30 to return to the initial position.

In the garden scissors mentioned above, the active blade 41 and the fixed blade 12 are used to cut the branch. Strengthened and hardened material is necessary to the active blade 41 and the fixed blade 12. Therefore, the active blade 41 and the fixed blade 12 may be made of carbon steel, stainless steel, or other metal or alloy. The gear portion 22 and the toothed member 42 are engaged by teeth thereon, rotating simultaneously to bring the active cutting edge 411 to move. Sufficient strength of material is also necessary. Rather than the material used in the active blade 41 and the fixed blade 12, the gear portion 22 and the toothed member 42 can be made of lighter metals, harder plastics, or composite plastics, such as fiber reinforced plastic. The handle portion 13 and the pulley portion 21 need only ordinary strength of material, which means lighter metals and plastics are applicable. Therefore, materials can be chosen for particular parts, members, and portions. Total weight of the garden scissors may be lowered without dropping structure strength, operational stability, and durability of the scissors.

Additionally, the flywheel portion 23 can increase total inertia of the transmission mechanism, and can abut against and lean against the chassis when the flywheel portion 23 rotates together with the pulley portion 21 and the gear portion 22. The flywheel portion 23 can help to support the gear portion 22 and the threaded axle 141, and bearing the non-axial torque generated by the driving line 30 and the gear portion 42. Structure of the transmission mechanism is strengthened and stabilized, strengthening structure of the garden scissors.

In view of the embodiments mentioned above, the garden scissors has a stabilized structure in transmitting force. Therefore, the garden scissors can be more durable and stable. Furthermore, the manufacturer can choose more lightened materials in producing the garden scissors to reduce the physical burden to the users. Therefore, the garden scissors is durable and easy to use.

What is claimed is:

1. A garden scissors, comprising:
a chassis, having a fixed cutting edge;
a transmission mechanism, disposed in the chassis, the transmission mechanism being rotatable about a central axis, the transmission mechanism including a pulley portion, a gear portion, and a flywheel portion, the pulley portion, the gear portion, and the flywheel portion being rotatable simultaneously about the central axis, the gear portion being located between the pulley portion and the flywheel portion, the flywheel portion having a radius larger than radius of the gear portion;
a driving line, having an end rolled and fixed on the pulley portion and another end extending away from the pulley portion;
a cutter, rotatably disposed to the chassis about a pivot axis, the cutter having an engagement portion and an active cutting edge, the engagement portion being engaged with the gear portion, the cutter being rotated by the gear portion to bring the active cutting edge moving approach to or away from the fixed cutting edge.

2. The garden scissors of claim 1, wherein the flywheel portion has a radius larger than twice the radius of the gear portion.

3. The garden scissors of claim 1, wherein an annular surface of the flywheel portion slidably contact the chassis.

4. The garden scissors of claim 1, wherein the flywheel portion has a thickness larger than one third the thickness of the gear portion.

5. The garden scissors of claim 1, wherein the pulley portion and the gear portion are coupled to rotate simultaneously, and the flywheel portion and the gear portion are integrally formed.

6. The garden scissors of claim 5, wherein one of the pulley portion and the gear portion has a non-circular hole, the other one has a protrusion, the protrusion is formed corresponding to and embedded in the non-circular hole, making the pulley portion and the gear portion unable to rotate with respect to each other.

7. The garden scissors of claim 1, wherein the cutter includes an active blade and a toothed member, the active blade is rotatably disposed to the chassis about the pivot axis, the toothed member is fixed on the active blade, and the engagement portion is formed on the toothed member.

8. The garden scissors of claim 7, wherein materials of the active blade and the toothed member are different.

9. The garden scissors of claim 1, wherein the garden scissors further includes an elastic member which abuts against the chassis and the cutter, providing the active cutting edge a potential to move away from the fixed cutting edge.

10. The garden scissors of claim 9, wherein the cutter has a pole, the elastic member is a torsion spring, and the elastic member sleeves on the pole.
